(19) United States
(12) Patent Application Publication
(10) Pub. No.: US 2015/0219530 A1
(43) Pub. Date: Aug. 6, 2015

(54) SYSTEMS AND METHODS FOR EVENT DETECTION AND DIAGNOSIS

(71) Applicant: ExxonMobil Research and Engineering Company, Annandale, NJ (US)

(72) Inventors: Weichang Li, Annandale, NJ (US); Thomas F. O'CONNOR, Washington, DC (US); Sourabh K. DASH, Beaumont, TX (US); Jeffrey J. SOMMERS, Fairfax, VA (US)

(73) Assignee: ExxonMobil Research and Engineering Company, Annandale, NJ (US)

(21) Appl. No.: 14/556,458

(22) Filed: Dec. 1, 2014

Related U.S. Application Data
(60) Provisional application No. 61/919,854, filed on Dec. 23, 2013.

(51) Int. Cl. G01M 99/00; G06F 17/18

(52) U.S. Cl. CPC G01M 99/008; G06F 17/18

(57) ABSTRACT

Detection of event conditions in an industrial plant includes receiving process data corresponding to one or more sensors, estimating normal statistics from the process data, estimating abnormal statistics from the process data with potentially abnormal operation of the one or more components, determining a fault model from the estimated normal and abnormal statistics, the fault model including a learning matrix, one or more fault indices indicating a likelihood of an occurrence of one or more fault events, and a fault threshold corresponding to the one or more sensors, determining one or more further fault indices from the further process data; applying the fault threshold to the one or more further fault indices, and indicating a further occurrence of the one or more fault events when a magnitude of the one or more further fault indices exceeds the fault threshold corresponding to the one or more sensors.

### CROSS-REFERENCE TO RELATED APPLICATIONS

This application claims priority to U.S. Provisional Application Ser. No. 61/919,854 filed Dec. 23, 2013, herein incorporated by reference in its entirety.

### BACKGROUND

1. Field of the Disclosed Subject Matter

The present disclosed subject matter relates to detecting, identifying and diagnosing fault events in an industrial plant, such as a refinery or petrochemical plant.

2. Description of Related Art

Conventional techniques for event detection include heuristic data-driven approaches, such as Principal Component Analysis (PCA) and parity space approaches, which develop detection models only based on statistics obtained during normal system operation. PCA based event detection generally defines normal operations based on historical relationships between measurements and determines that an event occurred when the deviation from the normal behavior crosses a user-defined limit. With respect to diagnosis, when an event is detected, the PCA model can attribute the most frequent causes to the sensor(s) most strongly correlated with certain loading vectors contributing to the detected deviation metric, and a human operator can then further diagnose and correct the situation based on prior experience.

Building such PCA models can require a large number of man-hours to screen the data to be utilized for the model, as well as to manually diagnose the causes of events when they occur. Additionally, the PCA models are generally determined by normal conditions and have low sensitivity due at least in part to not being specific to the emerging fault conditions. Furthermore, such models require additional efforts to “fine-tune” the models to suppress or eliminate false positive alerts. In addition, such models may need to be re-built each time there is a change to the equipment or control structure of the system being monitored. Furthermore, the PCA model output generally allows for relatively poor interpretation of faults, at least in part because the technique provides no direct correspondence to physical sensor variables or operational modes. The PCA model output also typically does not provide a suitable diagnostic function, at least in part because such techniques do not include an optimal estimator or classifier.

As such, there remains a need for improved systems and techniques for detecting, identifying and diagnosing fault events in an industrial plant.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter includes techniques for detection of event conditions in an industrial plant. An exemplary technique includes receiving process data corresponding to one or more sensors, estimating normal statistics from the process data associated with normal operation of one or more components corresponding to the one or more sensors, estimating abnormal statistics from the process data with potentially abnormal operation of the one or more components, determining a fault model from the estimated normal and abnormal statistics, the fault model including a learning matrix, one or more fault indices indicating a likelihood of an occurrence of one or more fault events, and a fault threshold corresponding to the one or more sensors, receiving the one or more fault indices, the fault threshold, and further process data from the one or more sensors, determining one or more further fault indices from the further process data, applying the fault threshold to the one or more further fault indices, and indicating a further occurrence of the one or more fault events when a magnitude of the one or more further fault indices exceeds the fault threshold corresponding to the one or more sensors.

For example and as embodied here, estimating the abnormal statistics can include performing a minimum mean squared error (MMSE) fault estimate on the process data. Determining the one or more further fault indices can include performing one or more of Neyman-Pearson Hypothesis testing and generalized likelihood ratio testing (GLRT) on the further process data.

Furthermore, and as embodied here, the technique can include dynamically adjusting the fault model using the further process data. Dynamically adjusting the fault model can include continuously updating the learning matrix based on updated estimates of the normal statistics and the abnormal statistics. Additionally or alternatively, dynamically adjusting the fault model can include adjusting the fault threshold using the one or more further fault indices associated with normal and abnormal segments of the further process data received over a predetermined time window.

Additionally, and as embodied here, the fault model can include a fault sensor map to relate the one or more sensors to the one or more components, and in some embodiments, the technique can further include, when the fault event is indicated, determining a faulty component corresponding to the at least one of the one or more sensors. The fault model can further include a fault dictionary stored in a database or a memory to relate patterns of the determined faulty components to the one or more fault events and a label having an operational meaning.

In some embodiments, the fault model can further include a root cause map to relate first sensor conditions corresponding to a first fault event of a first component to second sensor conditions corresponding to a second fault event of a second component, and the technique can further include determining a faulty system or group of systems corresponding to the related first and second sensor conditions. The technique can further include partitioning the one or more sensors based at least in part on a statistical dependence among the one or more sensors from a corresponding type of measurement performed. Additionally or alternatively, the technique can include partitioning the one or more sensors by a statistical and dynamical characterization of the one or more fault events.

According to another aspect of the disclosed subject matter, techniques for identification of event conditions in an industrial plant are provided. An exemplary technique includes receiving process data corresponding to one or more sensors, estimating normal statistics from the process data associated with normal operation of one or more components corresponding to the one or more sensors, estimating abnormal statistics from the process data with potentially abnormal operation of the one or more components, determining a fault model from the estimated normal and abnormal statistics, the fault model including a learning matrix, one or more fault indices indicating a likelihood of an occurrence of one or more fault events, and a fault threshold corresponding to the one or more sensors, receiving the one or more fault indices, the fault threshold, and further process data from the one or more sensors, determining one or more further fault indices from the further process data, applying the fault threshold to the one or more further fault indices, indicating a further occurrence of the one or more fault events when a magnitude of the one or more further fault indices exceeds the fault threshold corresponding to the one or more sensors, relating the one or more components to the one or more sensors exceeding the corresponding fault threshold, and identifying a type of the fault event based on the relation of the one or more components to the one or more sensors exceeding the corresponding fault threshold.

For example and as embodied here, estimating the abnormal statistics can include performing a minimum mean squared error (MMSE) fault estimate on the process data. Determining the one or more further fault indices can include performing one or more of Neyman-Pearson Hypothesis testing and generalized likelihood ratio testing (GLRT) on the further process data.

Furthermore, and as embodied here, the technique can include dynamically adjusting the fault model using the further process data. Dynamically adjusting the fault model can include continuously updating the learning matrix based on updated estimates of the normal statistics and the abnormal statistics. Additionally or alternatively, dynamically adjusting the fault model can include adjusting the fault threshold using the one or more further fault indices associated with normal and abnormal segments of the further process data received over a predetermined time window.

Additionally, and as embodied here, the fault model can include a fault sensor map to relate the one or more sensors to the one or more components, and in some embodiments, the technique can further include, when the fault event is indicated, determining a faulty component corresponding to the at least one of the one or more sensors. The fault model can further include a fault dictionary stored in a database or a memory to relate patterns of the determined faulty components to the one or more fault events and a label having an operational meaning.

In some embodiments, the fault model can further include a root cause map to relate first sensor conditions corresponding to a first fault event of a first component to second sensor conditions corresponding to a second fault event of a second component, and the technique can further include determining a faulty system or group of systems corresponding to the related first and second sensor conditions. The technique can further include partitioning the one or more sensors based at least in part on a statistical dependence among the one or more sensors from a corresponding type of measurement performed. Additionally or alternatively, the technique can include partitioning the one or more sensors by a statistical and dynamical characterization of the one or more fault events.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the disclosed subject matter. Together with the description, the drawings serve to explain the principles of the disclosed subject matter.

### BRIEF DESCRIPTION OF THE DRAWINGS

FIG. 1 is a schematic representation illustrating exemplary techniques for detecting, identifying and diagnosing fault events in an industrial plant according to the disclosed subject matter.

FIG. 2 is a diagram illustrating detection performance using exemplary techniques of FIG. 1.

FIG. 3 is a diagram illustrating exemplary techniques for determining an adaptively adjusted threshold level for use with the exemplary techniques of FIG. 1.

FIG. 4 is a diagram illustrating detection performance using exemplary techniques of FIG. 1 compared to PCA-based detection methods for purpose of illustration of the disclosed subject matter.

FIG. 5 is a diagram illustrating detection performance using exemplary techniques of FIG. 1 compared to PCA-based detection methods for purpose of illustration of the disclosed subject matter.

FIG. 6 is a diagram illustrating exemplary process data for use with the exemplary techniques of FIG. 1.

FIG. 7 is a diagram illustrating detection performance using exemplary techniques of FIG. 1 compared to PCA-based detection methods, using the exemplary process data of FIG. 6, for purpose of illustration of the disclosed subject matter.

FIG. 8 is a diagram illustrating detection performance and operation characteristics using exemplary techniques of FIG. 1 compared to PCA-based detection methods for purpose of illustration of the disclosed subject matter.

FIG. 9A is a diagram illustrating exemplary techniques for diagnosing fault events in an industrial plant according to the disclosed subject matter.

FIG. 9B is a detail view of estimated fault components in the region 9B of FIG. 9A.

FIG. 9C is a detail view of raw data of exemplary variables shown in region 9C of FIG. 9B.

FIG. 10A is a diagram illustrating exemplary techniques for diagnosing fault events in an industrial plant according to the disclosed subject matter.

FIG. 10B is a detail view of region 10B of FIG. 10A.

FIG. 11 is a diagram illustrating exemplary techniques for automatic sensor partitioning according to the disclosed subject matter.

FIG. 12 is a diagram illustrating exemplary techniques for automatic sensor partitioning according to the disclosed subject matter.

FIG. 13 is a diagram illustrating exemplary techniques for lower-dimensional space characterization of estimated faults according to the disclosed subject matter.

FIG. 14A is a diagram illustrating exemplary techniques for diagnosing fault events in an industrial plant according to the disclosed subject matter.

FIG. 14B is a diagram illustrating exemplary techniques for diagnosing fault events in an industrial plant according to the disclosed subject matter.

FIG. 15 is a flowchart illustrating exemplary techniques for diagnosing fault events in an industrial plant according to the disclosed subject matter.

### DETAILED DESCRIPTION OF THE PREFERRED EMBODIMENT

Reference will now be made in detail to the various exemplary embodiments of the disclosed subject matter, exemplary embodiments of which are illustrated in the accompanying drawings. The structure and corresponding techniques of the disclosed subject matter will be described in conjunction with the detailed description of the system.

The apparatus and methods presented herein can be used for event detection and/or diagnosis in any of a variety of suitable industrial systems, including, but not limited to, processing systems utilized in refineries, petrochemical plants, polymerization plants, gas utility plants, liquefied natural gas (LNG) plants, volatile organic compounds processing systems, liquefied carbon dioxide processing plants, and pharmaceutical plants. For purpose of illustration only and not limitation, and as embodied here, the systems and techniques presented herein can be utilized to identify and diagnose fault events in a refinery or petrochemical plant.

In accordance with one aspect of the disclosed subject matter herein, exemplary techniques for detecting, identifying and diagnosing fault events in an industrial plant generally include receiving process data corresponding to one or more sensors. Normal statistics are estimated from the process data associated with normal operation of one or more components corresponding to the one or more sensors. Abnormal statistics are estimated from the process data with potentially abnormal operation of the one or more components. A fault model is determined from the estimated normal and abnormal statistics, and the fault model includes a learning matrix, one or more fault indices indicating a likelihood of an occurrence of one or more fault events, and a fault threshold corresponding the one or more sensors. The one or more fault indices, the fault threshold, and further process data from the one or more sensors are received. One or more further fault indices are determined from the further process data. The fault threshold is applied to the one or more further fault indices. A further occurrence of the one or more fault events is indicated when a magnitude of the one or more further fault indices exceeds the fault threshold corresponding to the one or more sensors.

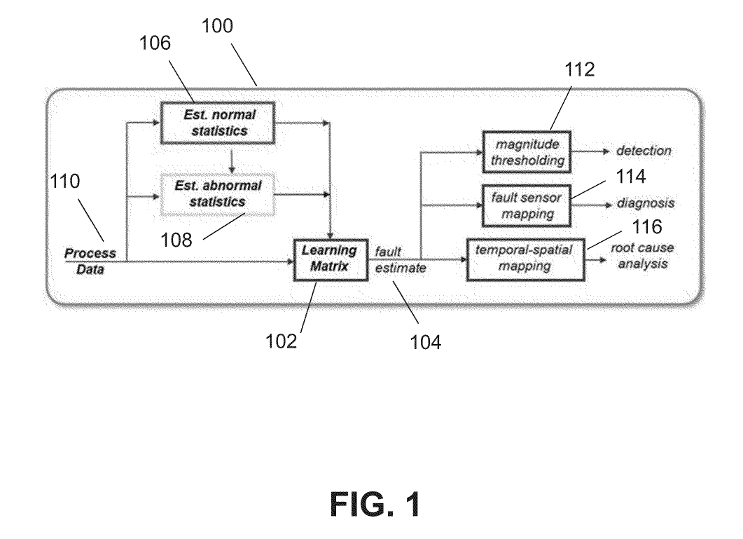

The accompanying figures, where like reference numerals refer to identical or functionally similar elements throughout the separate views, serve to further illustrate various embodiments and to explain various principles and advantages all in accordance with the disclosed subject matter. For purpose of explanation and illustration, and not limitation, exemplary systems and techniques for identifying and diagnosing fault events in an industrial plant in accordance with the disclosed subject matter are shown in FIGS. 1-15. While the present disclosed subject matter is described with respect to identifying and diagnosing fault events in a refinery or petrochemical plant, one skilled in the art will recognize that the disclosed subject matter is not limited to the illustrative embodiment, and that the systems and techniques described herein can be used to identify and/or diagnose fault events in any suitable industrial system or the like.

According to one aspect of the disclosed subject matter, with reference to FIG. 1, an exemplary system 100 for identifying and diagnosing fault events according to the disclosed subject matter include a learning matrix 102 to produce a fault estimate 104. As embodied herein, the learning matrix can incorporate statistics of both normal 106 and fault 108 processes estimated from process data 110 received from one or more sensors corresponding to various components in the industrial plant. In this manner, the normal and fault statistics of the learning matrix 102 can be regularly or continuously updated from a stream of measurement data received from the one or more sensors of the industrial plant.

A detection processor 112 can receive the fault estimate 104 from the learning matrix 102. The detection processor can perform one or more fault event detection techniques, which can include, for example and without limitation, binary hypothesis testing, described as follows. Additionally or alternatively, a fault analysis processor 114 can perform identification and/or diagnosis, for example by mapping fault sensors corresponding to one or more fault events. As a further alternative, a root cause analysis processor 116 can perform root cause analysis of the fault, for example by temporal and/or spatial mapping of the components corresponding to one or more fault events, as discussed further herein.

For purpose of illustration, and as embodied herein, event detection can include binary hypothesis testing. For example, measurement data y[n] can be received, and observation models for normal and fault event hypotheses, respectively represented as H0 and H1, can be utilized as follows:

H0:y[n]=x[n] (1)

H1:y[n]=x[n]+f[n] (2)

As such, n can represent a time index, and x[n] and f[n] can represent the normal process data and the process data associated with one or more fault events, respectively. In some embodiments, for fault diagnosis among several different types of faulty events, the binary hypothesis framework described here can be generalized to multiple hypothesis testing with Hj for each j^{th} type of fault.

Furthermore, and as embodied here, hypothesis testing can be performed according to a Neyman-Pearson hypothesis test, which can provide an improved or optimal detection probability at a given false positive rate. Additionally or alternatively, other suitable hypothesis tests can be performed, including and without limitation a Bayesian criterion test, which can reduce or minimize decision error for known prior data of Hj. For purpose of illustration and not limitation, and as embodied here, the Neyman-Pearson hypothesis test can be represented by following likelihood ratio testing at each time instant:

$$L ( y ) = \frac{p ( y \vert {H}_{1} )}{p ( y \vert {H}_{0} )} ⋛ r \qquad ( 3 )$$

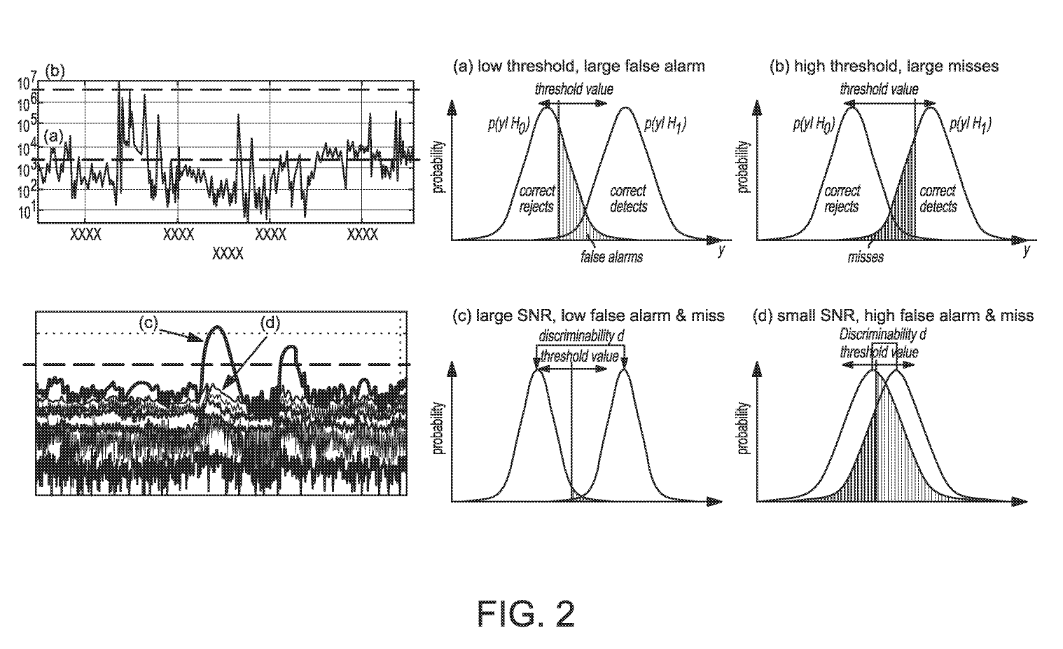

p(y|H₀) and p(y|H₁) can represent a likelihood function associated with each hypothesis, L(y) can represent a likelihood ratio, and r can represent a threshold value. The threshold value r can be chosen based at least in part on a desired balance between the resulting detection rate and false alarm rate of the fault detection. That is, increased values of r can reduce false positive rates but can also reduce detection probability, and reduced values of r can increase detection probability but can also increase false positives. For example, and with reference to FIG. 2, in the upper portion, a lower threshold (a) and a higher threshold (b) are overlaid together, for purpose of comparison, on a set of fault indices determined from example process data. Separately, p(y|H₀) and p(y|H₁) are plotted together and shown with the lower threshold (a) and higher threshold (b) indicated. As shown in FIG. 2, the lower threshold value produces more faults detected, but also more false positives, than the higher threshold value. Furthermore, as shown in the lower portion of FIG. 2, a signal detected with a relatively higher level of output signal-to-noise ratio (SNR) is indicated in a diagram representing example process data. Separately, p(y|H₀) and p(y|H₁) are plotted together and shown with an example threshold applied thereto. As shown in FIG. 2, the signal detected with a higher SNR in (c) provide lower false positives and less missed fault events compared to the signal detected with the lower SNR in (d).

With further reference to FIG. 2, adjusting the fault threshold level, from a lower level (a), to a higher level (b), can provide a tradeoff between the probability of detection and false positive rate. A performance gain can be obtained, for example for the same type of sensor data inputs, by increasing the SNR level in the fault index output to which the threshold is applied. The signal detected with the higher SNR in (c) illustrates a fault index obtained using exemplary techniques which has an increased SNR level compared to the signal of (d), which is obtained using PCA. The increased SNR in the fault index can allow increased detection probability with fixed false positive rate, or alternatively decreased false positive rate with fixed detection probability, or as a further alternative, simultaneously increased detection probability and decreased false positive rate at a reduced detection delay

The detection probability and false positive rates can be represented as

P_{d}=p(L(y)>r|H1), (4)

and

P_{f}=p(L(y)>r|H0) (5)

respectively. Generally, the detection probability and false positive rate can be considered universal, that is not specific to particular probability distributions of x, y, and f, and can be specialized and simplified to particular forms, including when x and f assume certain statistical models, such as, Gaussian regression models and the dynamic state-space models.

For example, and as embodied here, x and f can by represented as a Gaussian model, and as such, the log of the likelihood ratio, denoted as LL(y), can be represented as a function of a minimum mean squared error (MMSE) estimate of the faulty component, \hat{f}[n]. That is, LL(y) can be represented as

LL(y[n])=g(y[n],\hat{f}[n])=y^{t}[n]Q_{y}⁻¹μ_{f}+y^{t}[n]Qₓ⁻¹\hat{f}[n], (6)

and the MMSE fault estimate \hat{f}[n] can be represented as

\hat{f}[n]=μ_{f}+Q_{f}Q_{y}⁻¹(y[n]−μ_{y}) (7)

where Q_{f}, Pₓ=Qₓ⁻¹, P_{y}=Q_{y}⁻¹ can represent a covariance matrix of the estimated process data associated with a fault event f[n], the inverse covariance of the estimated normal process data x[n], and the inverse covariance of the observed process data y[n], respectively, and μ_{f}, μ_{y} can represent the mean of the potential fault event data and the input process data respectively. For purpose of illustration, the exemplary result described here represents estimated normal process data x[n] having a zero mean, and thus μ_{f} can equal μ_{y}, for example according to eq. (2). However, it is understood that the results herein can be extended to estimated normal process data x[n] having a non-zero mean.

As described herein, both the log likelihood ratio LL(y) and the MMSE fault estimate \hat{f}[n] can be determined by utilizing Q_{f}, Pₓ, P_{y} and μ_{f}. Furthermore, in operation, the observed process data y[n] can be obtained as a stream of measurement data received from the one or more sensors of the industrial plant. As such, Q_{f}, Pₓ, P_{y} and μ_{f} can be estimated from the observed process data y[n]. For example, and as embodied herein, the normal process data y[n] can be represented as a multivariate time series, and as such, the covariance can be approximated by a sampling covariance matrix estimated over K sample points, which can be represented as

\hat{Q}_{y}[n]=1/KΣ_{i=n-K+1}ⁿy[i]y^{t}[i] (8)

The inverse covariance P_{y} can be estimated as the inverse of \hat{Q}_{y}. Additionally, and as embodied herein, various constrained inverses can be used to obtain P_{y} from \hat{Q}_{y}, as discussed further herein below.

The fault event covariance matrix Q_{f} can be estimated from the received streaming data and the updated estimate of the normal statistics. For purpose of illustration, the faulty component data can be uncorrelated with the normal process data, and Q_{f} can be determined as the difference between \hat{Q}_{y} and the normal covariance estimate \hat{Q}ₓ, and can thus be represented as

\hat{Q}_{f}[n]=\hat{Q}_{y}[n]−\hat{Q}ₓ[n]. (9)

Symmetric non-negativity can be provided by projecting the resulting covariance estimate onto a positive convex space.

The normal covariance \hat{Q}ₓ[n] can be calculated from a predetermined set of historical process data known to be normal. Additionally or alternatively, the normal covariance \hat{Q}ₓ[n] can be updated from the stream of measurement data received from the one or more sensors of the industrial plant during one or more periods when no fault is detected. As a further alternative, which can be used for example to obtain an initial estimate, \hat{Q}ₓ[n] can be obtained by averaging process data y[n] over a suitably long period of time such that the time duration of fault events becomes negligible compared to the total time duration. Furthermore, the inverse of \hat{Q}ₓ[n], represented as \hat{P}ₓ, can be estimated as described further herein below.

The mean of the potential fault event data μ_{f} can be estimated by mean-centering the process data to remove the normal process mean level and determining a local running average of the mean-centered process data. Additionally, and as embodied herein, the estimated normal process data and the measured process data can be updated, for example, using a moving average of the measured process data over a predetermined time window. Additionally or alternatively, the estimated normal process data and the measured process data can be updated using dynamic models of both the estimated normal process data x[n] and the estimated fault event process data f[n]. For example, dynamic models including state-space models can be constructed for x[n] utilizing both first principle models and recent process data cleared of faulty events, and can be represented as

x[n+1]=Ax[n]+Bu[n]+w[n] (10)

where the model coefficients A and B can be fitted or calibrated against the recent normal process data and used for updating the normal statistics. For the fault event data f[n], heuristic statistical state-space models corresponding to the dynamics of the data can be used.

As such, Q_{f}, Pₓ, P_{y} and μ_{f} can be replaced by corresponding estimates \hat{Q}_{f}, \hat{P}_{y}, \hat{P}ₓ, and \hat{μ}_{f}, respectively, and the log likelihood ratio of eq. (6) in the Neyman-Pearson detector can thus be determined as

LL_{g}(y[n])=g(y[n],\hat{f}[n])=y^{t}[n]\hat{P}_{y}[n]\hat{μ}_{f}[n]+y^{t}[n]\hat{P}ₓ[n]\hat{f}[n], (11)

which can represent the generalized log likelihood ratio (GLRT), and the MMSE fault estimate can be represented as

\hat{f}[n]=\hat{μ}_{f}+\hat{Q}_{f}[n]\hat{P}_{y}[n](y[n]−\hat{μ}_{f}). (12)

As discussed herein, Q_{f}, Pₓ, P_{y} and μ_{f} can be utilized to determine the generalized likelihood ratio test (GLRT) of eq. (11) and the MMSE fault estimation in eq. (12). However, estimating P_{y} and Pₓ as the inverse of \hat{Q}_{y} and \hat{Q}ₓ, i.e., the sample covariance of y[n] and x[n], respectively, can be challenging when \hat{Q}_{y} or \hat{Q}ₓ is singular, which can occur, for example, due at least in part to insufficient data samples and/or cross-correlation among different element variables of y[n] or x[n]. As such, estimation of P_{y} from \hat{Q}_{y} can be regularized as

\hat{P}y=arg min_{P>0}−log det(P)+tr(P\hat{Q}_{y})+λ∥P∥_{η} (13)

where ∥P∥_{η} is a matrix norm of P, which can be, for example and without limitation, the l₁ norm of P when η=1. Such a norm can penalize on the absolute sum over all entries of P and thus can enhance sparsity. λ can represent a weighting factor on the regularization term. For example and without limitation, λ can equal 0, and thus eq. (13) can be determined by the maximum-likelihood estimate of P. λ can increase, and thus the solution of P can become more sparse. Although a closed-form solution to eq. (13) can be unavailable, eq. (13) can nevertheless be solved, for example and without limitation, using a graphical lasso technique, which can include one or more variants, such as exact covariance thresholding based accelerated graphical lasso. Similar techniques can be applied to obtain Pₓ from \hat{Q}ₓ.

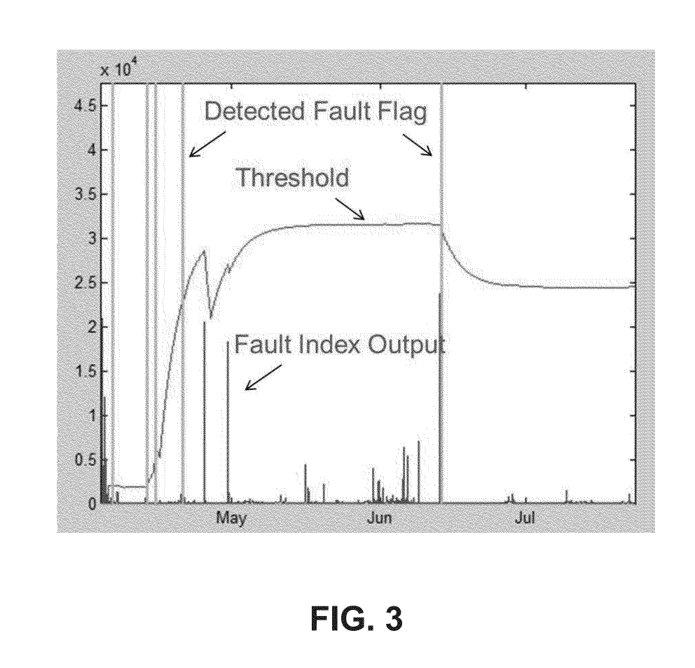

With reference now to FIG. 3, an exemplary technique for determining an adaptively adjusted threshold level is illustrated. For purpose of illustration, and not limitation, a fault event can be determined when the fault index, for example as determined based on the GLRT of eq. (11), exceeds a threshold level. The threshold level can be dynamically adjusted based on the fault indices determined based on the recent normal and abnormal data, and as embodied herein, a dynamically adjusted threshold level can be determined and applied to the fault index. In some embodiments, detection via thresholding can be performed using a binary hypothesis testing/classification technique. The normal and faulty process data can change over time, and can be characterized by the time-varying fault index output, and as such, the adaptive threshold can be chosen to yield suitable separation between the two sets of process data obtained in a recent predetermined time window.

For purpose of illustration, and as embodied herein, one or more time window buffers can be utilized to collect the fault index values associated with recent normal and fault data, and can be updated as new data is processed. In this manner, the threshold level can be chosen such that a desired false positive rate and detection probability can be met using the fault indices from both buffers. Additionally or alternatively, the threshold level can be determined using metric minimization, such as linear discriminant analysis (LDA). The determined threshold level can be further smoothed to improve robustness against outliers. Such adaptive thresholding techniques can be performed automatically or, if desired, can be tunable to incorporate operator inputs. In operation, real process data can be subject to drifting or dynamic change. As such, the adaptive thresholding techniques described herein can provide suitable desired detection performance according to the recent process characteristics, which can improve the performance and usability of the detector.

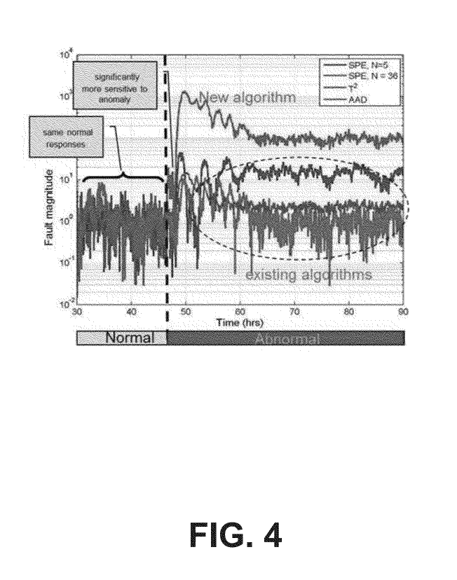

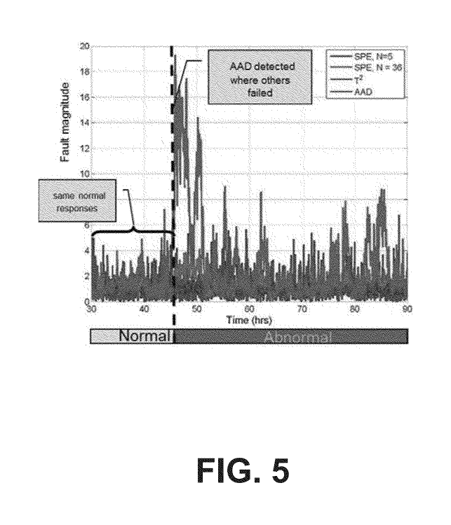

With reference now to FIGS. 4-5, exemplary results of fault identification according to the disclosed subject matter are compared to PCA-based techniques, for purpose of illustration of the advantages of the disclosed subject matter. The results of FIGS. 4-5 are based on a synthetic data set, referred to as Tennessee-Eastman Process data. FIG. 4 corresponds to a known fault event that is detectable by PCA-based techniques, such as squared prediction error (SPE) or T-squared (T²) analysis techniques.

As shown in FIG. 4, the sensitivity of the fault identification techniques according to the disclosed subject matter is higher than compared to the SPE and T² techniques based on PCA analysis for a wide range of PCA thresholding levels. As such, while both the techniques according to the disclosed subject matter and the PCA approach can detect the event, the techniques according to the disclosed subject matter provide a fault index with an SNR level orders of magnitude higher than that of PCA, which can correspond to reduced false positive rates, improved detection probability and/or reduced detection delay.

FIG. 5 illustrates a so-called subtle fault that was not detected by the PCA-based techniques. However, as shown in FIG. 5, the techniques according to the disclosed subject matter can detect such subtle faults not detected by the PCA approach. Furthermore, the output from the GLRT technique according to the disclosed subject matter shows improved peak SNR, and as such can provide robust detection of such subtle faults.

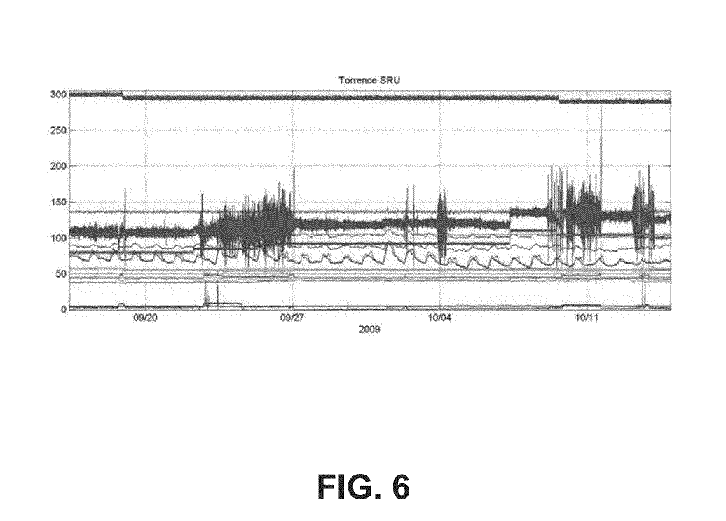

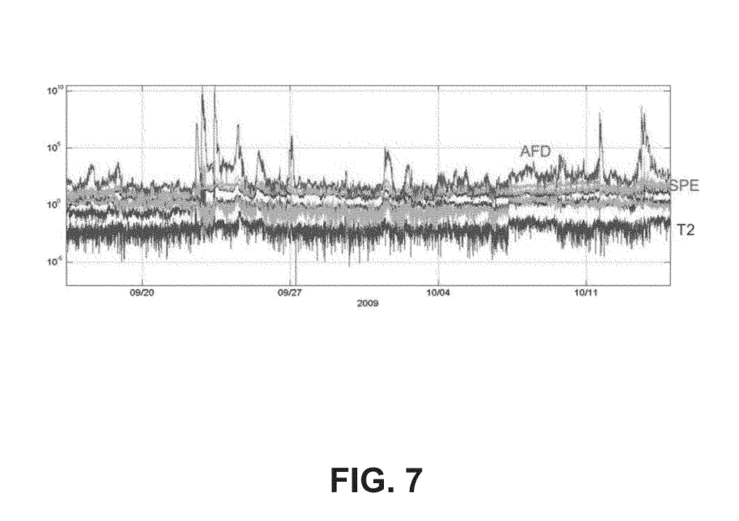

Referring now to FIGS. 6-7, further exemplary results of fault identification according to the disclosed subject matter are compared to PCA-based techniques, for purpose of illustration of the advantages of the disclosed subject matter. The results of FIGS. 6-7 are based on a set of real plant data having a total of 21 tag variables. FIG. 6 illustrates the raw process data obtained from the sensors identified by the 21 tag variables. Using the raw data of FIG. 6 as input, the event identification techniques described herein are performed and can generate an output having increased sensitivity than the SPE and T² techniques based on PCA analysis for a wide range of PCA thresholding levels, as shown for example in FIG. 7. Furthermore, as further illustrated in FIG. 7, the noise floor of the generated output is relatively flat, which can indicate improved performance against noise, and thus lower false positives compared to the SPE and T² techniques based on PCA analysis.

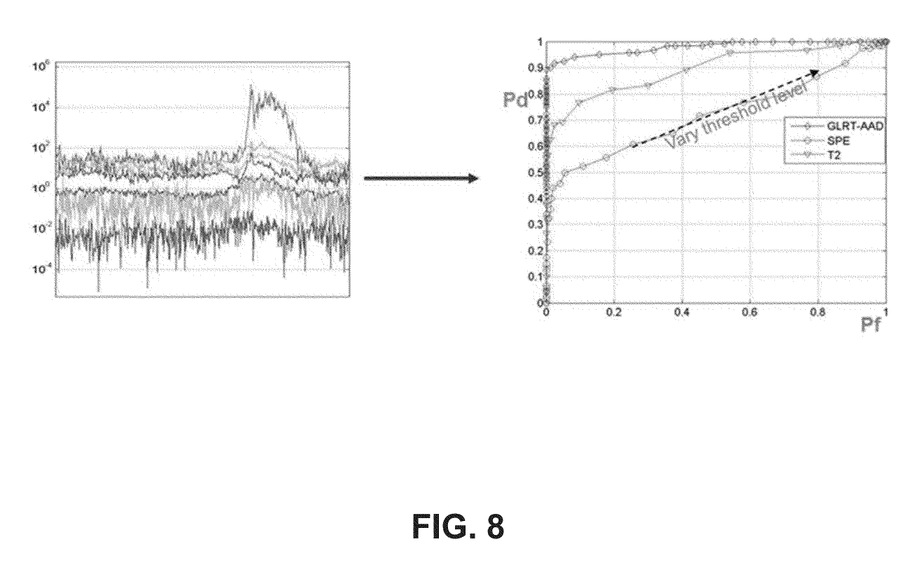

In FIG. 8, a segment of the event detector output is shown for purpose of illustrating the detection performance. The detection performance can be characterized by the so-called Receiver Operating Characteristics (ROC) curve, as shown in FIG. 8, where the horizontal axis can represent the false positive rates and the vertical axis can represent detection probability. The event detection output according to the disclosed subject matter appears closer to the north-west location of the ROC curve compared to the T² or SPE techniques, which can indicate reduced false positive rates at the same detection probability. For purpose of illustration and not limitation, as shown in FIG. 8, at detection probability 90%, the false positive rates for the GLRT, T² and SPE are 0, 43% and 82% respectively. As such, the T² and SPE techniques can be considered unsuitable for event detection at these false positive rates. By comparison, as shown in FIG. 8, the event detection techniques according to the disclosed subject matter perform with nearly zero false positives.

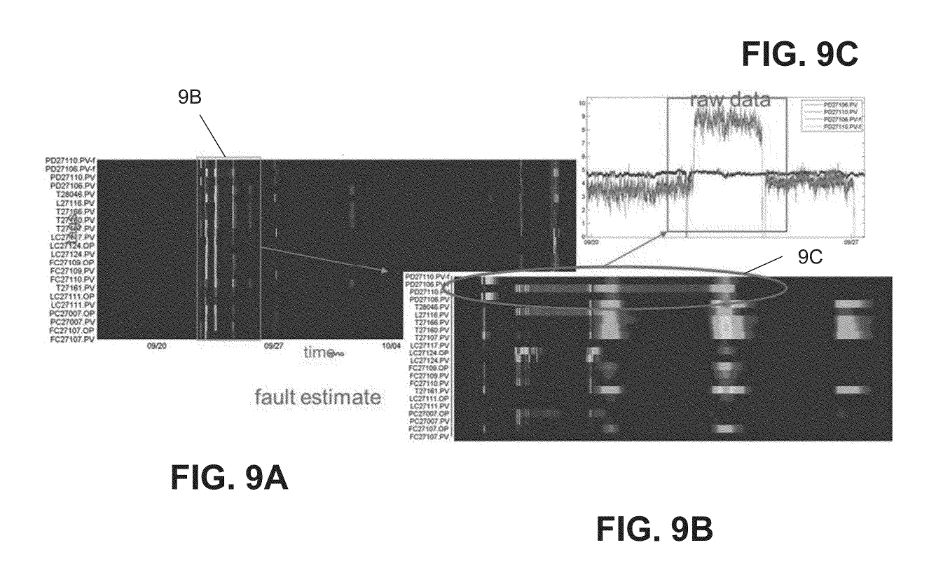

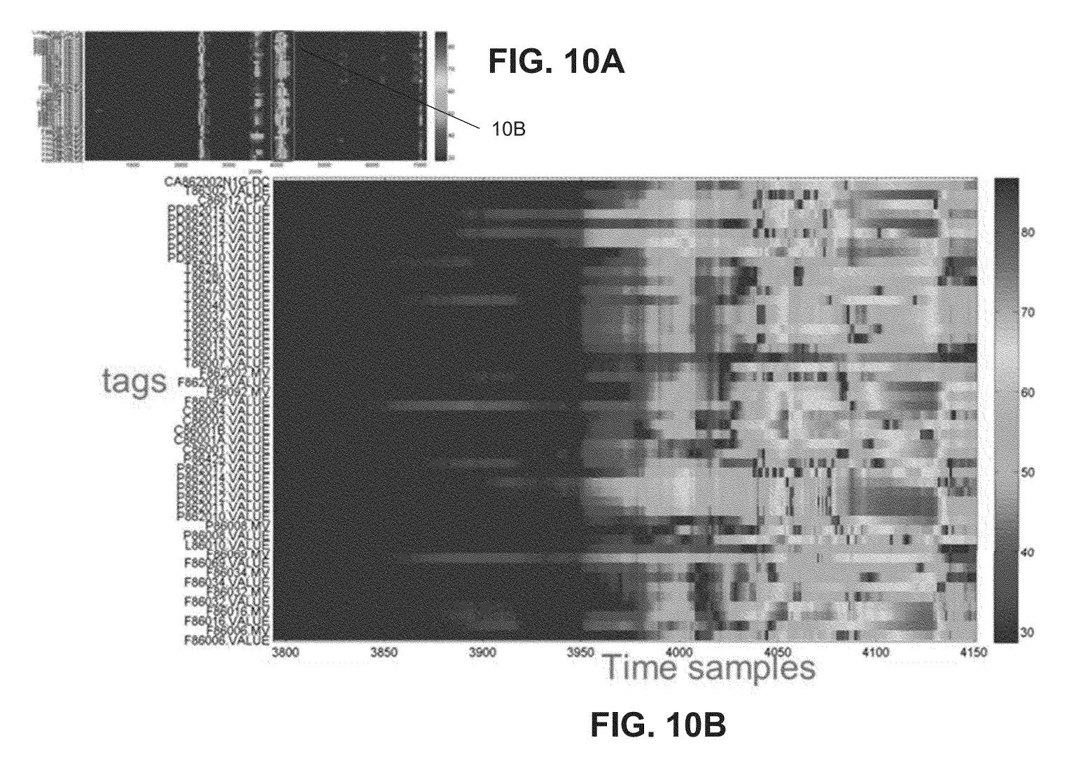

FIGS. 9A-9C and 10A-10B each illustrates an exemplary set of MMSE fault estimation results based on an independent plant data set. FIGS. 9A-9C each corresponds to the process data set illustrated in FIG. 6, and FIGS. 10A-10B each corresponds to a further independent plant data set. In each of FIGS. 9A-9B and 10A-10B, each row of the figure corresponds to a different tag variable over time. FIGS. 9B and 10B each is a detail view of a portion of FIGS. 9A and 10A, respectively, which provide increased detail examination of the fault components from each tag variable at the selected time windows. As illustrated in FIGS. 9A-9B and 10A-10B, each diagram illustrates the time trajectory of various fault events detected and further illustrates how a fault event can propagate over time to other tag variables, which can be useful for further analysis and classification of fault events, as discussed further herein below. FIG. 9C illustrates the raw process data corresponding to the tag variable identified in FIG. 9B.

For example and without limitation, and as embodied herein, inverse covariance estimation can be performed according to eq. (13), as discussed above. Furthermore, inverse covariance estimation in eq. (13) with η=1 can be referred to as a covariance selection problem, and can be related to the Gaussian Graphical model (GGM) representation of the multivariate sample data. An undirected graph G can be represented by a collection of nodes and the edges connecting the nodes, which can be represented as G=(V, E), where V, E can represent the set of nodes and edge coefficients respectively. In GGM the set of nodes V can be considered as the set of variables (i.e., tags) in the data and the edge coefficients E can be determined by the inverse covariance matrix of the data, e.g., P_{y} for y[n], as described herein. The connection between the nodes can have a statistical meaning. That is, the connection between the nodes can correspond to the conditional independence between nodes or variables. For example, unconnected nodes or variables can be considered conditionally independent, while connected nodes or variables can be considered dependent on each other.

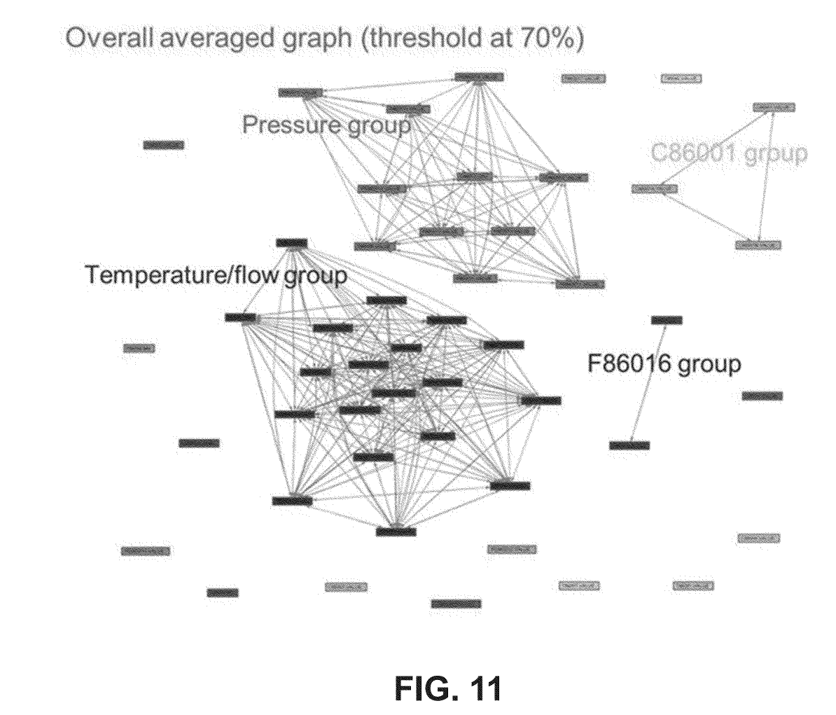

Furthermore, and as embodied herein, P_{y} can be determined as described herein, for example for calculating the Neyman-Pearson hypothesis test and the MMSE fault estimator. Accordingly, the same P_{y} can be utilized to directly determine the graph structure of the GGM graph structure of the process data. For purpose of illustration, FIG. 11 shows an exemplary GGM graph representation of a data set with 41 nodes. As shown in FIG. 11, the variable nodes can form several groups of connected subgraphs, and the nodes can be grouped, for example and without limitation, according to similar types of nodes (i.e., measured variables) and/or proximity in the process data topology.

In operation, for example in a relatively large-scale plant or production unit, the number of tag variables can be on the order of thousands. Nevertheless, a fault event, at least in an early stage, typically occurs at a local node before propagating to other nodes. As a result, a graph such as the GGM representation of FIG. 11 can evolve dynamically over time, which can provide certain advantages. For example, and as embodied herein, the GGM representation can allow the event analysis system to auto-partition a relatively large number of tag variables into small groups, for which tractable models can be built.

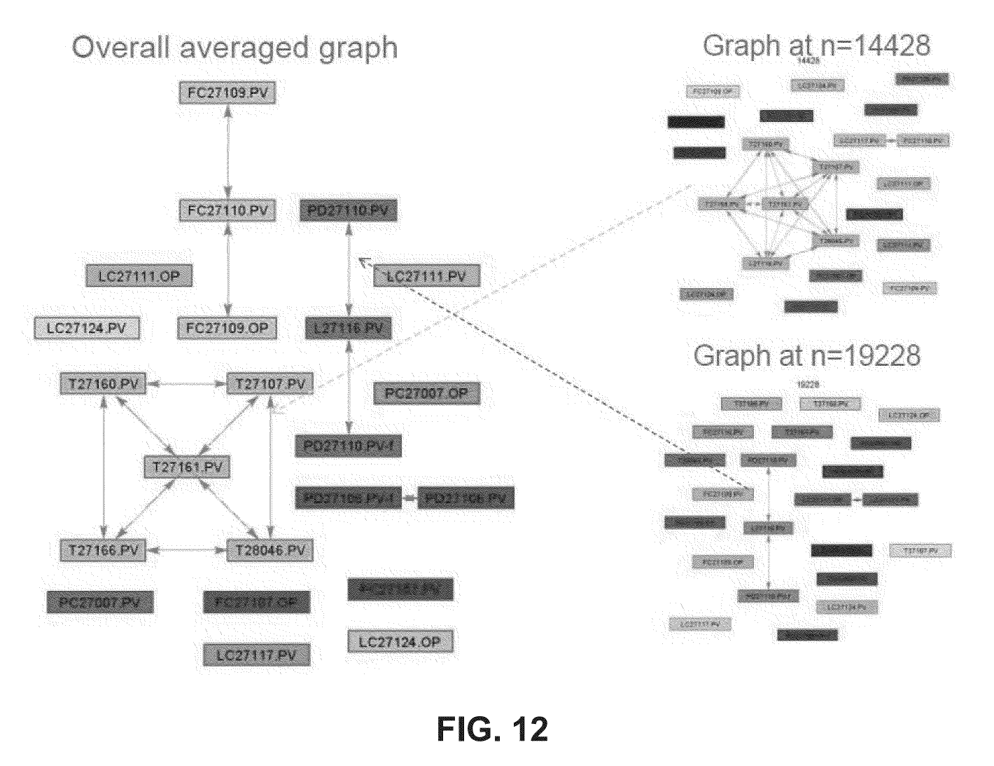

As a further example, as illustrated in FIG. 12, a GGM representation can be obtained from process data captured over a relatively long period of time, for example and as embodied herein, a period in a range of weeks, months or the entire history of the system, to capture the baseline statistical characteristics for the overall set of node variables. Additionally, discrete time windows can captured and updated with relatively short segments of recent process data, for example and as embodied herein over a period in a range of 1 to 24 hours, to capture fault events within each time window. In this manner, the resulting subgraph structure can associate certain variables responsible for a detected fault event at each time window, along with corresponding transient dynamics associated with the detected fault event, as shown for example in the subgraphs, illustrating exemplary time windows n=14428 and n=19228 in FIG. 12.

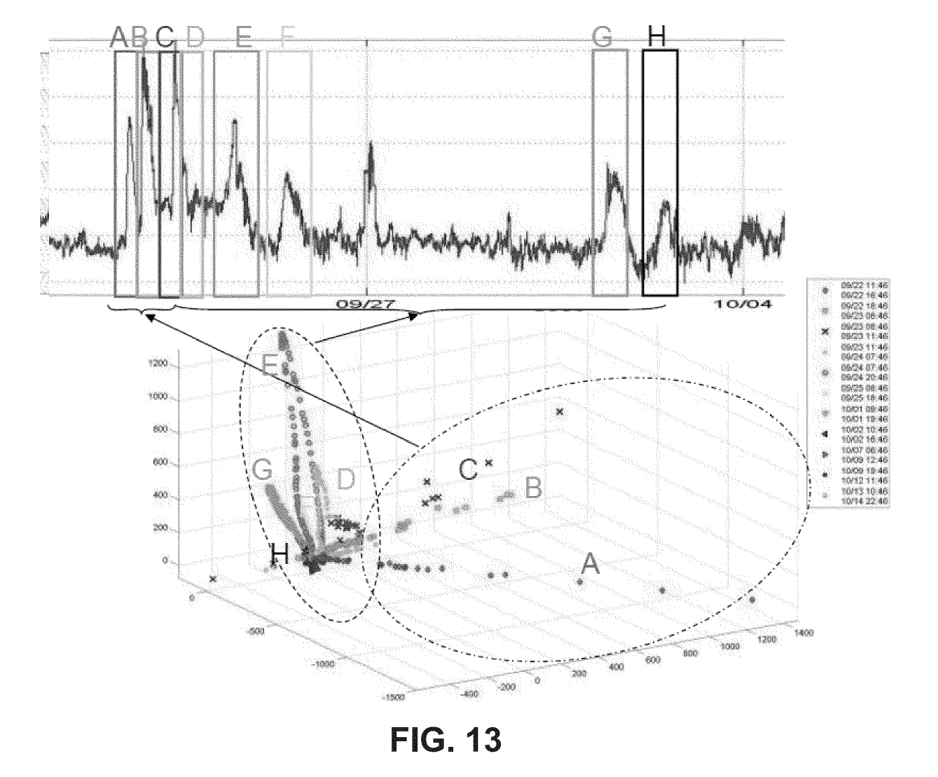

Referring now to FIG. 13, as embodied herein, during a fault event, the dynamics of faulty components over the time duration of a corresponding event can be represented in a spatial-temporal feature space, for example and without limitation, by projecting the sequence of fault estimates onto a lower dimensional space. The projected sequence can be used to compare unknown events with known ones, for example based on certain similarity measures. For example, as shown in FIG. 13, a group of eight identified fault events are plotted in a three-dimensional space, and each time sample is color-coded by group. The similarity of the known events to the unknown events, which can be determined by comparison of the temporal trajectory of the three-dimensional projections, can be used to compare fault events and classify unknown new events. That is, for example, unknown fault events can be grouped or associated with known fault events based at least in part on the determined similarity, as illustrated in FIG. 13.

For purpose of illustration and without limitation, and as embodied herein, the sequence of MMSE fault estimate \hat{f}[n] calculated according to eq. (12) can be utilized to determine the faulty components corresponding to each tag variable as a function of time. In such a calculation, according to the disclosed subject matter, the mean squared error can be reduced or minimal. For example and as embodied herein, a database of estimated faults and a corresponding fault labels can be represented as Lib({fᵢ,sᵢ}), where fᵢ can represent the i^{th} estimated fault data and sᵢ can represent an annotated fault label corresponding to the estimated fault data. The annotated fault label can be an operationally meaningful label, for example a textual or graphical label denoting that the fault corresponds to flooding or partial burning of a faulty component. As such, a newly detected and estimated fault can be represented as fₙ, and classification of the fault fₙ can be performed. That is, the annotated label of the fault fₙ can be represented as

sₙ=D(fₙ,Lib({fᵢ,sᵢ})) (14)

D(fₙ, Lib({fᵢ, sᵢ})) can represent the classification map function, which can be obtained various ways. For example and without limitation, the classification map function can be obtained by unsupervised techniques, such as clustering or metric learning. Additionally or alternatively, the classification map function can be obtained by supervised techniques, such as by a support vector machine (SVM) technique.

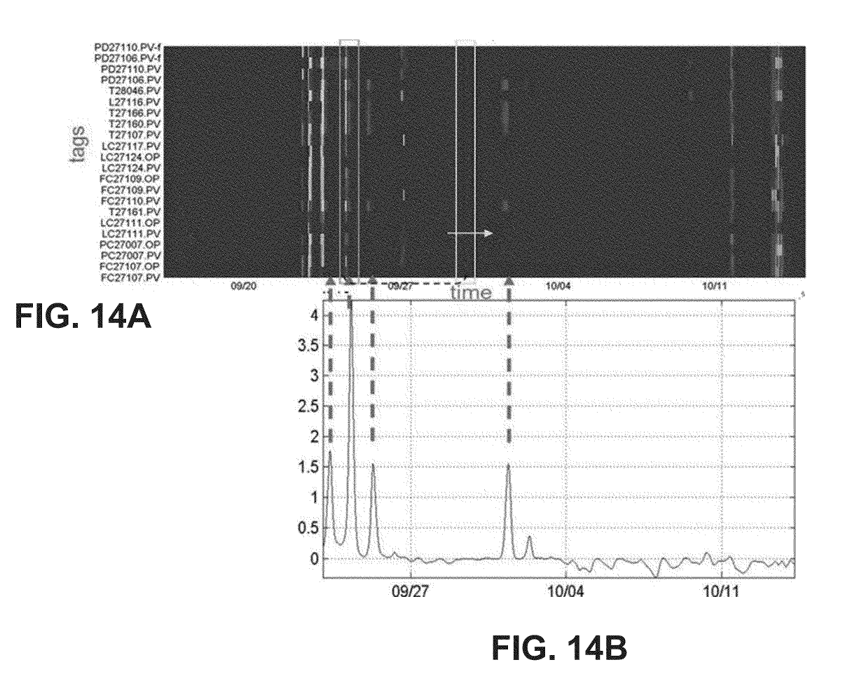

Referring now to FIGS. 14A-14B, a set of classification results based on the real plant data of FIG. 6 is illustrated. In FIG. 14A, the left box represents an annotated event whose estimated fault data and been determined and saved according to the techniques described herein. The right box moves along the time scale and can capture continuously generated fault estimates from the process data stream in real time. As such, a fault can be detected in the right box, for example and as discussed herein, by the process data corresponding to one or more sensors exceeding a threshold, and the corresponding estimated fault data can be sent to a classifier and compared to other known faults, such as the known fault represented in the left box. FIG. 14B illustrates an indication curve, which can provide classification results in terms of similarity of the new fault to one or more existing faults, if any. For purpose of illustration and simplification, FIG. 14B illustrates the similarity of one new fault to one known fault. However, the techniques described herein can be utilized to produce an indication curve generalized to a library of known faults.

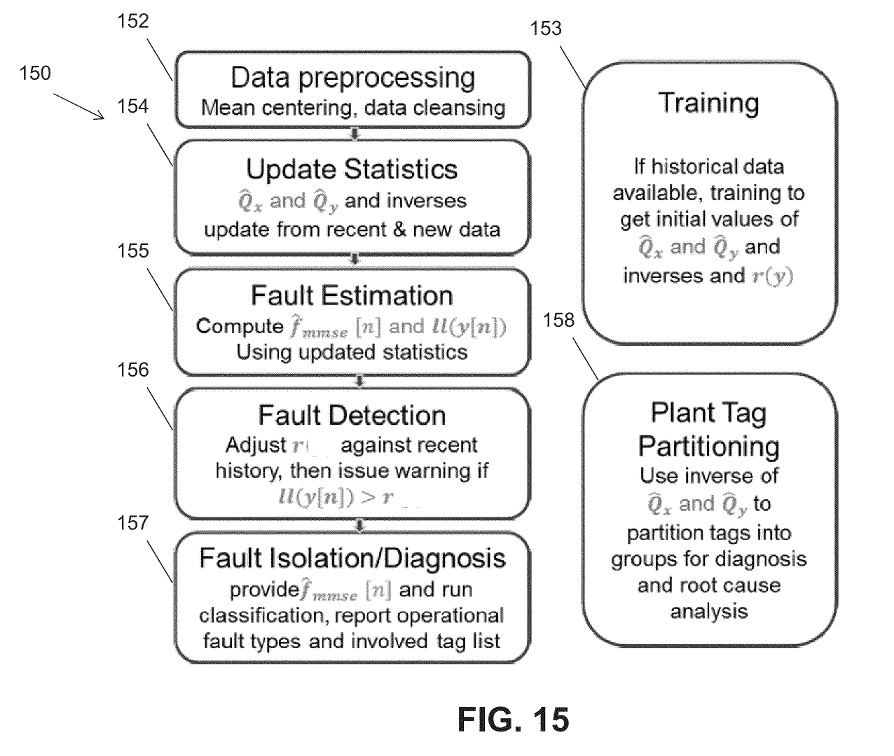

Referring now to FIG. 15, exemplary techniques 150 for detection and identification of fault events are illustrated. Exemplary techniques for detection and identification can include any combination of the steps illustrated in FIG. 15. As embodied herein, at 152, process data can be received, and preprocessing of the data can be performed. Mean centering of the data and cleansing of the data can be performed. For example, raw plant data can be contaminated by sensor saturation, temporary unit shut down or other operational issues that can be considered as normal operation yet can lead to outlier data values. Such data can be detected, isolated and replaced, for example, using interpolation and validation techniques.

In some embodiments, at 153, historical process data can be utilized to determine initial values for the covariance estimates \hat{Q}ₓ and the threshold value r.

At 154, the estimated statistics of normal data and fault data can be updated from the recent process data and any new data received, and the covariance estimates \hat{Q}ₓ and \hat{Q}_{y} can be determined as described herein. At 155, fault estimation can be performed using the updated statistics. For example, the MMSE estimate of a potential faulty component \hat{f}[n] can be determined and used to test the likelihood ratio L(y).

At 156, fault detection can be performed. For example, the log likelihood ratio LL(y) can be compared to the threshold r to determine the existence of a fault event, as described herein. Furthermore, in some embodiments, the threshold value r can be chosen based on recent process data to achieve a desired balance between the resulting detection rate and false alarm rate.

At 157, fault isolation and/or diagnosis can be performed. For example, as described herein, the MMSE estimate of the faulty component \hat{f}[n] can be utilized to determine the faulty components corresponding to each tag variable as a function of time. Classification of the fault fₙ can be performed, for example by classification mapping, as described herein. At 158, in some embodiments, tag variables can be partitioned into groups for diagnosis and root cause analysis, as described herein.

### ADDITIONAL EMBODIMENTS

Additionally or alternatively, the disclosed subject matter can include one or more of the following embodiments:

### Embodiment 1

A technique for detection of event conditions in an industrial plant includes receiving process data corresponding to one or more sensors, estimating normal statistics from the process data associated with normal operation of one or more components corresponding to the one or more sensors, estimating abnormal statistics from the process data with potentially abnormal operation of the one or more components, determining a fault model from the estimated normal and abnormal statistics, the fault model including a learning matrix, one or more fault indices indicating a likelihood of an occurrence of one or more fault events, and a fault threshold corresponding to the one or more sensors, receiving the one or more fault indices, the fault threshold, and further process data from the one or more sensors, determining one or more further fault indices from the further process data, applying the fault threshold to the one or more further fault indices, and indicating a further occurrence of the one or more fault events when a magnitude of the one or more further fault indices exceeds the fault threshold corresponding to the one or more sensors.

### Embodiment 2

The technique of any of the foregoing Embodiments, wherein estimating the abnormal statistics includes performing a minimum mean squared error (MMSE) fault estimate on the process data.

### Embodiment 3

The technique of any of the foregoing Embodiments, wherein determining the one or more further fault indices includes performing one or more of Neyman-Pearson Hypothesis testing and generalized likelihood ratio testing (GLRT) on the further process data.

### Embodiment 4

The technique of any of the foregoing Embodiments, including dynamically adjusting the fault model using the further process data.

### Embodiment 5

The technique of Embodiment 4, wherein dynamically adjusting the fault model includes continuously updating the learning matrix based on updated estimates of the normal statistics and the abnormal statistics.

### Embodiment 6

The technique of Embodiment 4 or 5, wherein dynamically adjusting the fault model includes adjusting the fault threshold using the one or more further fault indices associated with normal and abnormal segments of the further process data received over a predetermined time window.

### Embodiment 7

The technique of any of the foregoing Embodiments, wherein the fault model includes a fault sensor map to relate the one or more sensors to the one or more components, and the technique includes, when the fault event is indicated, determining a faulty component corresponding to the at least one of the one or more sensors.

### Embodiment 8

The technique of Embodiment 7, wherein the fault model includes a fault dictionary stored in a database or a memory to relate patterns of the determined faulty components to the one or more fault events and a label having an operational meaning.

### Embodiment 9

The technique of any of the foregoing Embodiments, wherein the fault model includes a root cause map to relate first sensor conditions corresponding to a first fault event of a first component to second sensor conditions corresponding to a second fault event of a second component, and the technique includes determining a faulty system or group of systems corresponding to the related first and second sensor conditions.

### Embodiment 10

The technique of any of the foregoing Embodiments, including partitioning the one or more sensors based at least in part on a statistical dependence among the one or more sensors from a corresponding type of measurement performed.

### Embodiment 11

The technique of any of the foregoing Embodiments, including partitioning the one or more sensors by a statistical and dynamical characterization of the one or more fault events.

### Embodiment 12

A technique for identification of event conditions in an industrial plant includes receiving process data corresponding to one or more sensors, estimating normal statistics from the process data associated with normal operation of one or more components corresponding to the one or more sensors, estimating abnormal statistics from the process data with potentially abnormal operation of the one or more components, determining a fault model from the estimated normal and abnormal statistics, the fault model including a learning matrix, one or more fault indices indicating a likelihood of an occurrence of one or more fault events, and a fault threshold corresponding to the one or more sensors, receiving the one or more fault indices, the fault threshold, and further process data from the one or more sensors, determining one or more further fault indices from the further process data, applying the fault threshold to the one or more further fault indices, indicating a further occurrence of the one or more fault events when a magnitude of the one or more further fault indices exceeds the fault threshold corresponding to the one or more sensors, relating the one or more components to the one or more sensors exceeding the corresponding fault threshold, and identifying a type of the fault event based on the relation of the one or more components to the one or more sensors exceeding the corresponding fault threshold.

### Embodiment 13

The technique of any of the foregoing Embodiments, wherein estimating the abnormal statistics includes performing a minimum mean squared error (MMSE) fault estimate on the process data.

### Embodiment 14

The technique of any of the foregoing Embodiments, wherein determining the one or more further fault indices includes performing one or more of Neyman-Pearson Hypothesis testing and generalized likelihood ratio testing (GLRT) on the further process data.

### Embodiment 15

The technique of any of the foregoing Embodiments, including dynamically adjusting the fault model using the further process data.

### Embodiment 16

The technique of Embodiment 15, wherein dynamically adjusting the fault model includes continuously updating the learning matrix based on updated estimates of the normal statistics and the abnormal statistics.

### Embodiment 17

The technique of Embodiment 15 or 16, wherein dynamically adjusting the fault model includes adjusting the fault threshold using the one or more further fault indices associated with normal and abnormal segments of the further process data received over a predetermined time window.

### Embodiment 18

The technique of any of the foregoing Embodiments, wherein the fault model includes a fault sensor map to relate the one or more sensors to the one or more components, and the technique includes, when the fault event is indicated, determining a faulty component corresponding to the at least one of the one or more sensors.

### Embodiment 19

The technique of Embodiment 18, wherein the fault model includes a fault dictionary stored in a database or a memory to relate patterns of the determined faulty components to the one or more fault events and a label having an operational meaning.

### Embodiment 20

The technique of any of the foregoing Embodiments, wherein the fault model includes a root cause map to relate first sensor conditions corresponding to a first fault event of a first component to second sensor conditions corresponding to a second fault event of a second component, and the technique includes determining a faulty system or group of systems corresponding to the related first and second sensor conditions.

### Embodiment 21

The technique of any of the foregoing Embodiments, including partitioning the one or more sensors based at least in part on a statistical dependence among the one or more sensors from a corresponding type of measurement performed.

### Embodiment 22

The technique of any of the foregoing Embodiments, including partitioning the one or more sensors by a statistical and dynamical characterization of the one or more fault events.

While the disclosed subject matter is described herein in terms of certain preferred embodiments, those skilled in the art will recognize that various modifications and improvements can be made to the disclosed subject matter without departing from the scope thereof. Moreover, although individual features of one embodiment of the disclosed subject matter can be discussed herein or shown in the drawings of the one embodiment and not in other embodiments, it should be apparent that individual features of one embodiment can be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

1. A method for detection of event conditions in an industrial plant, comprising:
receiving process data corresponding to one or more sensors;
estimating normal statistics from the process data associated with normal operation of one or more components corresponding to the one or more sensors;
estimating abnormal statistics from the process data with potentially abnormal operation of the one or more components;
determining, by a model processor, a fault model from the estimated normal and abnormal statistics, the fault model comprising a learning matrix, one or more fault indices indicating a likelihood of an occurrence of one or more fault events, and a fault threshold corresponding the one or more sensors;
receiving, by a detector processor operably coupled to the model processor, the one or more fault indices, the fault threshold and further process data from the one or more sensors;
determining one or more further fault indices from the further process data;
applying the fault threshold to the one or more further fault indices; and
indicating a further occurrence of the one or more fault events when a magnitude of the one or more further fault indices exceeds the fault threshold corresponding to the one or more sensors.

2. The method of claim 1, wherein estimating the abnormal statistics comprises performing a minimum mean squared error (MMSE) fault estimate on the process data.

3. The method of claim 1, wherein determining the one or more further fault indices comprises performing one or more of Neyman-Pearson Hypothesis testing and generalized likelihood ratio testing on the further process data.

4. The method of claim 1, further comprising dynamically adjusting the fault model using the further process data.

5. The method of claim 4, wherein dynamically adjusting the fault model comprises continuously updating the learning matrix based on updated estimates of the normal statistics and the abnormal statistics.

6. The method of claim 4, wherein dynamically adjusting the fault model comprises adjusting the fault threshold using the one or more further fault indices associated with normal and abnormal segments of the further process data received over a predetermined time window.

7. The method of claim 1, wherein the fault model further comprises a fault sensor map to relate the one or more sensors to the one or more components, the method further comprising, when the fault event is indicated, determining, by a diagnosis processor, a faulty component corresponding to the at least one of the one or more sensors.

8. The method of claim 7, wherein the fault model further comprises a fault dictionary stored in a database or a memory to relate patterns of the determined faulty components to the one or more fault events and a label having an operational meaning.

9. The method of claim 1, wherein the fault model further comprises a root cause map to relate first sensor conditions corresponding to a first fault event of a first component to second sensor conditions corresponding to a second fault event of a second component, the method further comprising, determining, by a root cause processor, a faulty system or group of systems corresponding to the related first and second sensor conditions.

10. The method of claim 1, further comprising partitioning the one or more sensors based at least in part on a statistical dependence among the one or more sensors from a corresponding type of measurement performed.

11. The method of claim 1, further comprising partitioning the one or more sensors by a statistical and dynamical characterization of the one or more fault events.

12. A method for identification of event conditions in an industrial plant, comprising:
receiving process data corresponding to one or more sensors;
estimating normal statistics from the process data associated with normal operation of one or more components corresponding to the one or more sensors;
estimating abnormal statistics from the process data with potentially abnormal operation of the one or more components;
determining, by a model processor, a fault model from the estimated normal and abnormal statistics, the fault model comprising a learning matrix, one or more fault indices indicating a likelihood of an occurrence of one or more fault events, and a fault threshold corresponding the one or more sensors;
receiving, by a detector processor operably coupled to the model processor, the one or more fault indices, the fault threshold and further process data from the one or more sensors;
determining one or more further fault indices from the further process data;
applying the fault threshold to the one or more further fault indices;
indicating a further occurrence of the one or more fault events when a magnitude of the one or more further fault indices exceeds the fault threshold corresponding to the one or more sensors;
relating the one or more components to the fault threshold corresponding to the one or more sensors; and
identifying a type of the one or more fault events based on the relation of the one or more components to the fault threshold corresponding to the one or more sensors.

13. The method of claim 12, wherein estimating the abnormal statistics comprises performing a minimum mean squared error (MMSE) fault estimate on the process data.

14. The method of claim 12, wherein determining the one or more further fault indices comprises performing one or more of Neyman-Pearson Hypothesis testing and generalized likelihood ratio testing on the further process data.

15. The method of claim 12, further comprising dynamically adjusting the fault model using the further process data.

16. The method of claim 15, wherein dynamically adjusting the fault model comprises continuously updating the learning matrix based on updated estimates of the normal statistics and the abnormal statistics.

17. The method of claim 15, wherein dynamically adjusting the fault model comprises adjusting the fault threshold using the one or more further fault indices associated with normal and abnormal segments of the further process data received over a predetermined time window.

18. The method of claim 12, wherein the fault model further comprises a fault sensor map to relate the one or more sensors to the one or more components, the method further comprising, when the fault event is indicated, determining, by a diagnosis processor, a faulty component corresponding to the at least one of the one or more sensors.

19. The method of claim 18, wherein the fault model further comprises a fault dictionary stored in a database or a memory to relate patterns of the determined faulty components to the one or more fault events and a label having an operational meaning.

20. The method of claim 12, wherein the fault model further comprises a mot cause map to relate first sensor conditions corresponding to a first fault event of a first component to second sensor conditions corresponding to a second fault event of a second component, the method further comprising, determining, by a root cause processor, a faulty system or group of systems corresponding to the related first and second sensor conditions.

21. The method of claim 12, further comprising partitioning the one or more sensors based at least in part on a statistical dependence among the one or more sensors from a corresponding type of measurement performed.

22. The method of claim 12, further comprising partitioning the one or more sensors by a statistical and dynamical characterization of the one or more fault events.
